(19) United States
(12) Patent Application Publication
(10) Pub. No.: US 2005/0128213 A1
(43) Pub. Date: Jun. 16, 2005

(54) Image rendering apparatus and method using mipmap texture mapping

(76) Inventors: Bart Gerard Bernard Barenbrug, Eindhoven (NL); Kornellis Meinds, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/498,604

(22) PCT Filed: Dec. 16, 2002
(86) PCT No.: PCT/IB02/05468

(30) Foreign Application Priority Data
Dec. 20, 2001 (EP) 01205044.9

(51) Int. Cl. G09G 5/00

(52) U.S. Cl. 345/587

(57) ABSTRACT

The invention relates to a computer graphics systems and a method for rendering an image for display using texture mapping. A combination of the advantages of 3D mipmapping and 4D mipmapping is achieved according to the invention by: storing texture maps in 3D mipmap format, reconstructing at least part of a 4D mipmap from said 3D mipmap on-the-fly, and mapping texture data from said 4D mipmap to corresponding pixel data defining said display image.

The invention relates to a computer graphics system and a method for rendering an image for display using texture mapping. Further, the invention relates to a computer and a computer program.

An important element in rendering 3D graphics is texture mapping. To perform texture mapping, a 2D picture has to be mapped onto the screen. It is often the case that the 2D picture has to be minified considerably in this process. To reduce the bandwidth required for reading the 2D picture, a pre-processing step is often performed in which several downscaled versions of the 2D picture are created. During texture mapping, the part of only the smaller downscaled picture which matches best in resolution with the screen image is read and mapped to the screen. The 2D picture along with its downscaled versions is called a mipmap. Texture mapping as well as mipmaps are particularly described in “Survey of Texture Mapping”, Paul S. Heckbert, IEEE Computer Graphics and Applications, November 1986, pp. 56-67 and in U.S. Pat. No. 6,236,405 B1.

There are several types of mipmaps, varying in which downscaled images are stored. In a 3D mipmap, both directions are downscaled by the same factors, while in a 4D mipmap the original image is downscaled independently in both dimensions.

Compared to the 3D mipmap the 4D mipmap arrangement, however, costs a lot of bandwidth to read and a lot of memory to store, and therefore often the 3D mipmap structure is used. In the 3D mipmap arrangement, only the diagonal of the 4D mipmap is stored.

In general, there are several methods known for mapping the (mipmapped) image onto the screen grid. One of these methods is two-pass forward texture mapping. In this method, the 2D mapping is decomposed in two 1D mappings. First, the image is mapped in one direction, e.g. in horizontal direction, then in the other direction, e.g. in the vertical direction. In one such mapping stage, it is preferred to map in one direction, i.e. by varying the minification factor in that direction, which means that the minification factor is kept constant in the other direction. The 4D mipmap arrangement is ideal for this purpose, since it enables to stick to one column or row of the collection of images embedded in the 4D mipmap. However, it is preferred to use the low bandwidth and memory requirements of the 3D mipmap structure where it is not possible to keep one minification factor constant while varying the other minification factor.

It is therefore an object of the present invention to provide an improved computer graphics system and method for rendering an image for display which provide a solution to the above-mentioned problem and which combine the advantages of 3D and 4D mipmapping.

This object is achieved by a computer graphics system as claimed in claim 1 comprising:
a texture memory for storing texture maps in 3D mipmap format,
a mipmap reconstruction means for on-the-fly reconstruction of at least part of
a texture map of a 4D mipmap from said 3D mipmap read from said texture memory, and a texture mapping means for mapping texture data from said 4D mipmap to corresponding pixel data defining said display image.

The object is further achieved by a corresponding method as claimed in claim 8. A computer program comprising program code means for causing a computer to perform the steps of this method when said computer program is run on a computer is claimed in claim 9.

The invention is based on the idea to only pre-calculate and store the 3D mipmap levels and to calculate 4D mipmap levels from these on-the-fly, i.e. while the rendering of the image is performed, particularly when performing the texture mapping. During rendering, when data from a 4D mipmap is needed, the 3D mipmap data is read from the texture memory, and filtering is applied to generate the required 4D mipmap data, which is then immediately used. In this way, the advantages of both arrangements are used, i.e. the advantages of 3D mipmapping requiring only a low memory size and bandwidth and the advantages of 4D mipmapping allowing more freedom in mipmap selection and the ability to select the proper level for two-pass algorithms are combined. Since the downscaling that is performed to generate the mipmap structures, i.e. the texture maps forming the mipmaps, is very regular (with a power of 2), the up-scaling required to reconstruct the 4D mipmap can be done very efficiently.

As an alternative to up-scaling, a 4D mipmap level can also be generated by (on-the-fly) downscaling a 3D mipmap level. For example: mipmap level (2,1) might be generated by up-scaling level (2,2) vertically, but it can also be generated by downscaling level (1,1) horizontally. The latter uses more bandwidth, but retains the high resolution vertical detail which is present in level (1,1). This factor-2 downscaling might be useful (instead of simply texture mapping directly from level (1,1)), because it allows the use of a texture mapping filter which is limited to at most a factor of two downscaling. With known texture methods, this down-scaling-in-advance can yield an anisotropic filter footprint which can improve image quality. Combinations are of course also possible, e.g. level (3,1) may be generated by downscaling from level (1,1), by up-scaling from level (3,3), or by the combination of up- and downscaling from level (2,2).

Preferred embodiments of the invention are included in the dependent claims. As mentioned above two known methods are one-pass 2D mapping and two-pass 1D mapping. 2D mapping uses a 2D filter structure, whereas 1D mapping uses two 1D filter structures in sequence. There are several advantages and disadvantages to each method. A 2D filter structure takes all the texel colors in a footprint (which is 2D) and processes them. A two-pass 1D structure handles these texel colors by first warping them horizontally and then warping them vertically (or vice versa). According to a preferred embodiment of the invention two-pass 1D texture mapping is applied by the texture mapping means.

According to another preferred embodiment said mipmap reconstruction means include a reconstruction filter for vertically up-scaling a lower-resolution texture map of said 3D mipmap to obtain a higher-resolution texture map of said 4D mipmap before horizontally up-scaling said higher-resolution texture map. Said embodiment is preferably applied for two-pass 1D texture mapping. Therein the proper mipmap level (or texture map) can be selected from those available. In the first pass an intermediate picture is generated which serves as the input to the second pass. Therefore the second pass does not have a choice between different resolution input pictures. So no extra scaling is done on the intermediate image before the second pass. However, it is possible that the stretching that occurs to generate a 4D mipmap level for the first pass involves horizontal scaling. This alternative is useful in an embodiment where the first pass of the two passes of a two-pass filtering method is a vertical filtering pass and the second pass is the horizontal filtering pass. Thus, a 3D mipmap level is horizontally scaled to generate a 4D mipmap level that serves as the input for the first pass. An alternative embodiment is defined in claim 4.

Should reconstruction have to be performed from a mipmap level that is not the next downscaled or up-scaled version, a recursive reconstruction can be applied. Therein, a higher-resolution texture map is stepwise reconstructed from a texture map having a lower resolution of the next lower level or from a texture map having a higher resolution of the next higher level. This provides the advantage that a simple “one-level” reconstruction hardware can be used.

The invention will now be explained in more detail with reference to the drawings in which

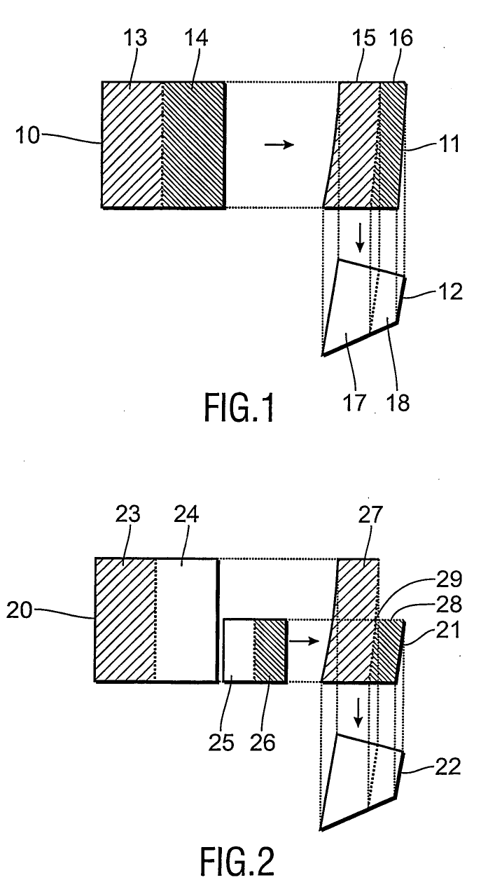

FIG. 1 illustrates a first known two-pass texture filtering option,

FIG. 2 illustrates a second known texture filtering option,

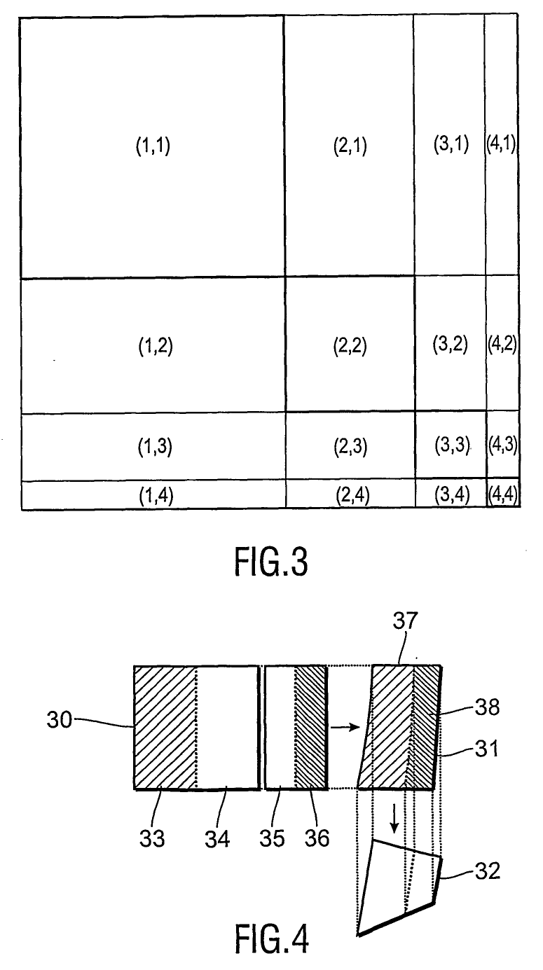

FIG. 3 shows a 4D mipmap arrangement,

FIG. 4 illustrates a third known two-pass texture filtering option,

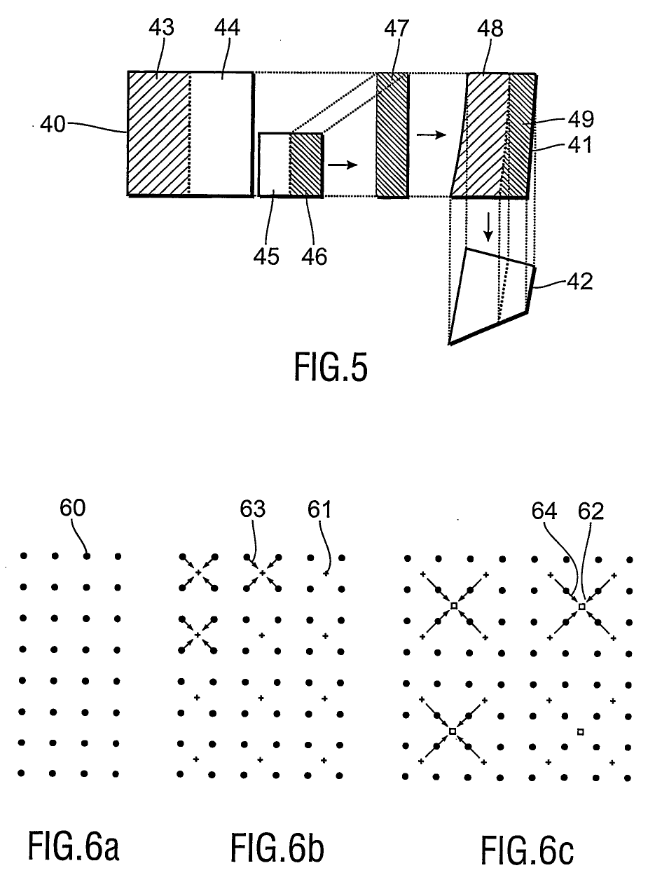

FIG. 5 illustrates a two-pass texture filtering option according to the invention,

FIG. 6a-c illustrates the construction of mipmap levels,

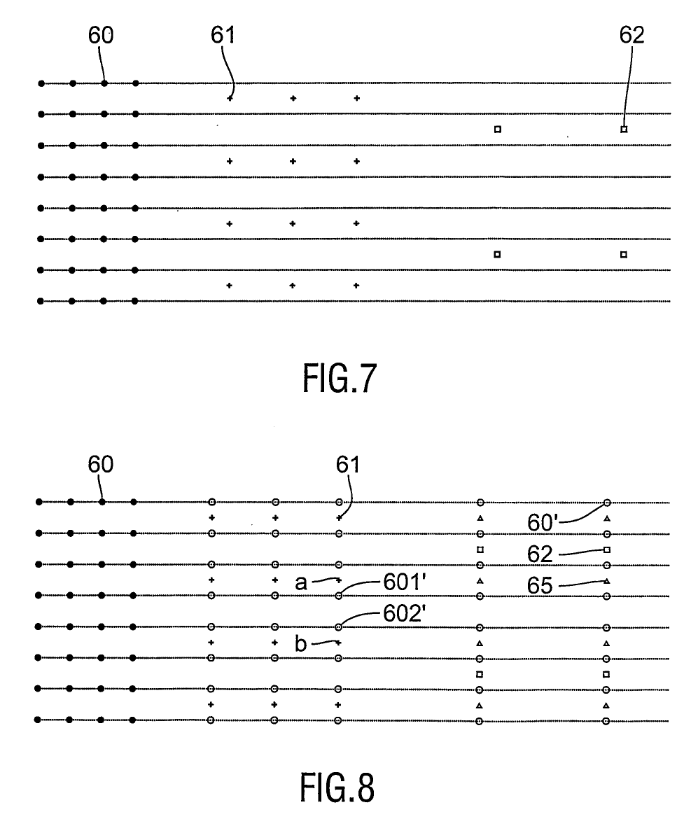

FIG. 7a-c illustrates samples read from different mipmap levels,

FIG. 8a-c illustrates sample reconstruction according to the invention, and

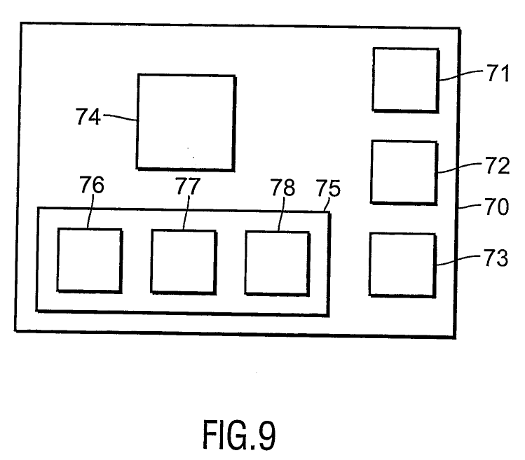

FIG. 9 shows a block-diagram of a computer according to the invention.

For two-pass 1D forward mapping, the first pass uses the original texture as a source. This texture can be stored in mipmapped format. The output of the first pass is an intermediate image. In the second pass, this intermediate image is transformed to the output image, but since the intermediate image was only generated in the first pass, there are no different mipmap levels available for it. So a general mipmap approach is not applicable to the second pass.

In FIG. 1 a first embodiment of a known two-pass texture filtering option is illustrated. Therein, a square texture map 10 is rotated clockwise and then around a vertical axis so that the right side 14 of the texture 10 moves away from the viewer. The figure shows the two filter passes, i.e. first horizontally, then vertically, by showing the original texture 10, having original portions 13, 14, the intermediate image 11, having intermediate portions 15,16, and the final image 12, having final portions 17, 18. Since the right original portion 14 of the texture map 10 is mapped onto a much smaller screen area 18 than the left original portion 13 which is mapped onto screen area 17, the texels that are used for this portion could come from a higher mipmap level, i.e. from a texture map having a lower resolution.

FIG. 2 shows what would happen if indeed the right portion 26 would be generated from a lower-resolution mipmap. This assumes the conventional 3D mipmap arrangement where lower-resolution mipmaps are formed by unweighted averaging of four texels of the higher-resolution mipmap into one texel of the lower-resolution version, i.e. mipmaps are down-scaled equally horizontally and vertically by powers of two. Since the 1D filters map one input line to one output line, the left and right parts 23, 26 of the texture map 20 now end up in different vertical resolutions in the intermediate image 21. In general, the intermediate image will consist of different parts 27, 28 stemming from different mipmap levels. This can be seen from the vertical gap 29 between the two parts 27, 28 of the intermediate image 21. Portions 24, 25 of the original texture map 20 are, however, not used.

This complicates both passes a lot. In the first pass, the disjunct parts of the intermediate image have to be assigned to different areas of the intermediate image, and an administration has to be set up to relay this information to the second pass. The second pass needs to read this information and combine the appropriate parts again, which is complicated since filtering samples in the neighbourhood of a mipmap level transition means combining samples from different parts of the intermediate image. The cause of this complexity is the presence of different vertical scaling factors in the intermediate image. This cause can be removed by using so-called 4D mipmaps.

In the 4D mipmap arrangement, the down-scaled versions of the original texture map are scaled independently in the vertical and horizontal directions, resulting in the arrangement depicted in FIG. 3. Therein, the block labeled (1, 1) is the original texture map, and it is scaled (by e.g. powers or factors of two) independently in u and v directions. With traditional 3D mipmaps, both directions are sampled by the same factors, yielding only the diagonal blocks (1, 1), (2,2), (3,3), (4,4) of the exemplary arrangement shown in FIG. 3.

Using this 4D mipmap arrangement a constant vertical scaling factor can be kept. This is shown in FIG. 4. Therein mipmap level (2,1) is chosen instead of (2,2) to generate the right part 38 of the intermediate image 31. The filter of the first pass can now process samples from one line (consisting of segments stemming from different mipmap levels in the u coordinate, but with constant v mipmap level) without any extra work. The second pass is the same as in the non-mipmapped case, since the intermediate image 31 does not show the use of mipmaps anymore. However, the intermediate image has been generated in a more efficient way than it would have been without mipmapping: For the right side 38 only half the bandwidth for reading texels is used which also means that less texels had to be processed. Again, portions 34, 35 of the original texture map 30 are not used, but only portions 33, 36 to achieve intermediate portion 37, 38 from which the final image 32 is reconstructed.

There are several drawbacks however. According to the option depicted in FIG. 2 even less texels are read from texture memory (only a quarter for generating the right side 28, since now only area 26 is read from the texture memory, instead of area 14), showing that bandwidth usage of the 3D approach is better than that of the 4D approach, where it is kept artificially high at times to ensure constant vertical scaling. Furthermore, the 4D mipmap arrangement is much more memory intensive than the regular 3D mipmap arrangement: It costs three times as much memory to store a 4D mipmap arrangement than it does to store a 3D mipmap arrangement. It is thus preferred to combine the advantages of 3D mipmapping and 4D mipmapping. This is done according to the invention by using 3D mipmapped textures and reconstructing the 4D mipmap arrangement on-the-fly, i.e. while rendering is performed.

On-the-fly 4D mipmap reconstruction is illustrated in FIG. 5. Therein, the texels for the right portion 49 of the intermediate image 41 are read from a regular 3D mipmap structure, but the right portion 49 is vertically up-scaled to another intermediate portion 47, i.e. it is on-the-fly reconstructed, to match the left portion 48 before the horizontal filter pass is started to obtain the final image 42. In this way, the low bandwidth requirements associated with 3D mipmaps can still be kept, but in addition the constant vertical scaling factor from the 4D mipmap arrangement can also be achieved. The latter keeps the first filter pass simple. Since the same intermediate image is generated, the second is also simple. Thus, according to the invention only portions 43, 46 of the original texture map 40 are used while portions 44, 45 are not used.

Using this on-the-fly up-scaling which is relatively easy in the preferred embodiment since it is only required to expand with powers of two, all read textures are brought to the same vertical resolution. Before traversing a triangle, it is needed to determine which resolution this is going to be. It is therefore needed to calculate for example the highest resolution encountered, which is easily determined by the derivatives at the three vertices. The highest resolution gives the highest picture quality, but lower resolutions require less bandwidth.

To determine how the vertical up-scaling is to be performed, it can be looked in detail at how lower-resolution mipmap levels are filtered from the original texture map. This is illustrated in FIG. 6. FIG. 6a only shows the samples (the dots) 60 from the original texture map. FIG. 6b also shows the samples (the plusses) 61 from the first mipmap level. FIG. 6c also shows the samples (the squares) 62 from the second mipmap level. The arrows 63 or 64, respectively, show how one new sample of a lower-resolution mipmap is generated by unweighted averaging of four samples of the higher-resolution mipmap. The averaging corresponds to a special case of bilinear filtering, where the new sample is located exactly in the middle of the four original samples.

When a texture is read in a 3D mipmapped way, the different mipmap samples would be read as shown in FIG. 7. These samples need to be used to drive the first (horizontal) filter pass. But as the dotted lines in FIG. 7 show, there are no complete rows that can be filtered so that the lower-resolution mipmaps have to be scaled up vertically as was shown in FIG. 5. This up-scaling means reconstructing the texture map in a higher resolution. This is shown in FIG. 8, where the samples 60′ (the open circles) shall be generated which together with the samples 60 (the dots) form the rows that can feed the horizontal 1D filter, by vertically reconstructing the texel colors from the lower-resolution samples 61, 62. To do this properly, a reconstruction filter is needed.

Properly reconstructing samples 60′ is not very critical. In this case, however, the second pass will do the proper filtering with a wide footprint. Only if there are many different mipmap levels within one primitive, i.e. the lowest-resolution mipmap has to be magnified a lot. Usually, such up-scaling in the 4D mipmap reconstruction is accompanied by similar downscaling in the second pass, so in these rare cases it is not very noticeable.

The simplest filter is the box filter, which is equal to nearest-neighbour selection. With this filter the samples 60′ are simply copies of the nearest lower-resolution sample 61 or 62. However, since the grid structure for the reconstruction is very regular, it is very easy and cheap to implement a better filter profile.

Using the tent filter, the samples 60′ are a linear combination of two neighbouring lower-resolution samples 61. When the up-sampling factor is a power of two, the weight factors are constant: The two samples 601′, 602′ between two vertically adjacent lower-resolution samples a, b are one quarter and three quarters between the two lower-resolution samples a, b and can therefore be reconstructed as (3a+b)/4 and (a+3b)/4. Special hardware can be made to perform this interpolation efficiently, and thus perform the reconstruction from the one mipmap level higher. It is needed to keep track of the previous line of read samples to have both lower-resolution samples a, b available for the interpolation. This costs a line of memory, which is prohibitive if tile based rendering is not performed. For higher order filters more lines of memory are correspondingly needed.

Should reconstruction have to be performed from a mipmap level that is not the next down-scaled version, the same “one level” reconstruction hardware can be used recursively. This recursive process can be seen in FIG. 8 where the samples 60′ (the open circles) on the right can be constructed from the lower-resolution samples 62 (the squares) by first generating the samples 65 (the triangles) from the samples 62 (the squares), i.e. by applying the “one level” reconstruction, and thereafter reconstructing the samples 60′ (the open circles) from the samples 65 (the triangles) by again applying the “one level” reconstruction. The recursive process can be implemented by an iterative process in a time shared manner, i.e. no different hardware is required. The slow-down of this time sharing is not that prohibitive, since more than two mipmap levels per primitive is probably a rare case since such primitives are oriented at a large angle from the viewer, which means they do not occupy a lot of screen area.

A block diagram of a computer including a computer graphics system according to the invention is shown in FIG. 9. The computer 70 comprises as main elements a central processing unit 71, a memory 72, an input device 73, a display 74 and a computer graphics system 75. Said computer graphics system 75 which may be implemented as a graphics processor further comprises as elements which are essential for the present invention a texture memory 76 for storing texture maps in 3D mipmap format, a mipmap reconstruction unit 77 for on-the-fly reconstruction at least a part of a texture map of a 4D mipmap from said 3D mipmap stored in said texture memory 76, and a texture mapping unit 78 for mapping texture data from said 4D mipmap to corresponding pixel data defining said display image to be displayed on said display 74.

1. Computer graphics system for rendering an image for display using texture mapping, comprising:
a texture memory for storing texture maps in 3D mipmap,
a mipmap reconstruction means for on-the-fly reconstruction of at least part of a texture map of a 4D mipmap from said 3D mipmap read from said texture memory, and
a texture mapping means for mapping texture data from said 4D mipmap to corresponding pixel data defining said display image.

2. Computer graphics system as claimed in claim 1,
wherein said mipmap reconstruction means are adapted for two-pass 1D texture mapping.

3. Computer graphics system as claimed in claim 1,
wherein said mipmap reconstruction means include a reconstruction filter for vertically up-scaling a lower-resolution texture map of said 3D mipmap to obtain a higher-resolution texture map of said 4D mipmap before horizontally up-scaling said higher resolution texture map.

4. Computer graphics system as claimed in claim 1,
wherein said mipmap reconstruction means include a reconstruction filter for horizontally downscaling a higher-resolution texture map of said 3D mipmap to obtain a lower-resolution texture map of said 4D mipmap before vertically downscaling said lower-resolution texture map.

5. Computer graphics system as claimed in claim 1,
wherein said mipmap reconstruction means are adapted for recursively reconstructing said 4D mipmap by stepwise reconstructing a higher-resolution texture map from a texture map having a lower resolution of the next lower level or reconstructing a lower-resolution texture map from a texture map having a higher resolution of the next higher level.

6. Computer graphics system as claimed in claim 1,
wherein said mipmap reconstruction means are adapted for reconstructing said at least a part of a texture map of said 4D mipmap by either downscaling from a higher-resolution texture map of said 3D mipmap or by up-scaling from a lower-resolution texture map of said 3D mipmap.

7. Computer comprising
a central processing unit, a memory, an input device, a display and a computer graphics system as claimed in claim 1.

8. Method of rendering an image for display using texture mapping, comprising the steps of:
storing texture maps in 3D mipmap format,
reconstructing at least part of a 4D mipmap from said 3D mipmap on-the-fly, and
mapping texture data from said 4D mipmap to corresponding pixel data defining said display image.

9. Computer program comprising program code means for causing a computer to perform the steps of the method as claimed in claim 8 when said computer program is run on a computer.
